(19) United States
(12) Patent Application Publication
(10) Pub. No.: US 2008/0209052 A1
(43) Pub. Date: Aug. 28, 2008

(54) System and Method for Delivering Value Added Services from Services Providers

(75) Inventors: Corey Velan, Montreal (CA); Erik Wright, Montreal (CA); Marty Algire, Montreal (CA); Luc Boulianne, Montreal (CA); Mario Contestabile, Laval (CA); Craig Frisch, Montreal (CA); Thierry Baron, Montreal (CA); Carlos Saldanha, St-Hilaire (CA); Benjamin Skowronski, Montreal (CA); Frank Kouretas, Montreal (CA)

Correspondence Address: OSLER, HOSKIN & HARCOURT LLP (Radialpoint), 1000 DE LA GAUCHETIERE STREET WEST, SUITE 2100, MONTREAL, QC, H3B-4W5, omitted

(73) Assignee: RADIALPOINT INC., Montreal (CA)

(21) Appl. No.: 11/677,665

(22) Filed: Feb. 22, 2007

(51) Int. Cl. G06F 15/16

(52) U.S. Cl. 709/228

(57) ABSTRACT

A method and system for delivering value added service (VAS) applications offered by a service provider to a subscribing end user is presented. The method includes collecting, by a user service module, end user device information, forwarding, by the service provider, end user information, to a server, creating, by the service provider, target end user profiles, VAS application campaigns, and campaign schedules, and storing the same in the server. The method further comprises communicating, between the server and the user service module, to display an offer in the end user device for at least one of the VAS applications, in accordance with the target profiles, the application campaigns, and schedules, wherein, upon selecting by the user, the at least one of the VAS applications is loaded, installed, and activated in the end user device without further end user actions.

### BACKGROUND OF THE INVENTION

1. Field of the Invention

The present invention generally relates to the field of communications and networking, and more particularly to a system and method for delivering service applications to end user devices via the Internet.

2. Description of the Related Art

The explosive growth of Internet users has lead to increasing demands for more resources and services, forcing service providers to create new products, such as value-added service (VAS) applications, to satisfy these demands. The term “service providers” is intended to encompass any entity capable of offering such VAS applications to end users and may include, but not limited to, Internet service providers (ISPs), software developers/providers, software distributors, telecommunication service providers, etc. In addition, the VAS applications, may include, but not limited to, firewall applications, antivirus applications, virtual hosting applications, gaming applications, etc.

Despite these offerings, however, end users often have difficulty obtaining, downloading, and installing the VAS applications offered by service providers. And, in many instances, service providers often have problems with public awareness, marketing/advertising, and the distribution of such applications to the general public.

### SUMMARY OF THE INVENTION

The principles of the present invention, as embodied and broadly described herein, provide a method and system for creating an entirely new channel of delivering value added service (VAS) applications to end users. In one embodiment, a method of delivering value added service (VAS) applications offered by a service provider to a subscribing end user is presented, in which the method comprises collecting, by a user service module, end user device information; forwarding, by the service provider, end user information, to a server; creating, by the service provider, target end user profiles, VAS application campaigns, and campaign schedules; and storing the end user information, the end user device information, the target end user profiles, the VAS application campaigns, and the campaign schedules in the server. The method further comprises communicating, between the server and the user service module, to display an offer in the end user device for at least one of the VAS applications, in accordance with the target end user profiles, the VAS application campaigns, and the campaign schedules, wherein, upon selecting by the user, the at least one of the VAS applications is loaded, installed, and activated in the end user device without further end user actions.

According to a another aspect of the invention, there is provided a system for delivering value added service (VAS) applications offered by a service provider to a subscribing end user, comprising an end user device incorporating a user service module that is configured to collect end user device information and a server configured to receive and store end user information from the service provider, end user device information from the user service module, and target end user profiles, VAS application campaigns, and campaign schedules created by the service provider. The system further comprises that the server and the user service module communicate to display an offer in the end user device for at least one of the VAS applications, in accordance with the target end user profiles, the VAS application campaigns, and the campaign schedules and that, upon selecting by the user, the at least one of the VAS applications is loaded, installed, and activated in the end user device without further end user actions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a system level configuration, according to an embodiment of the invention;

FIG. 2A depicts a functional block diagram of a user service module, according to an embodiment of the invention;

FIG. 2B depicts a functional block diagram of a server, according to an embodiment of the invention;

FIGS. 3A, 3B depict flowcharts for initial installations, according to embodiments of the invention;

FIG. 3C depicts a general flowchart for ISP campaigning, according to an embodiment of the invention;

FIG. 4 depicts a flowchart for end-to-end delivery of service applications, according to an embodiment of the invention; and

FIGS. 5A, 5B depict the throttling process, according to an embodiment of the invention.

### DETAILED DESCRIPTION OF THE INVENTION

To overcome the limitations noted above, the present invention is directed to a method and system for creating an entirely new channel of delivering value added service (VAS) applications to end users. In particular, the present invention employs inter alia, an Internet-based transmission channel and a user service module (USM) on an end user device that communicates, via the channel, with a server that houses the VAS applications and related subscription information in cooperation with a service provider, and initiates the installation and activation of selected VAS applications on the end user device.

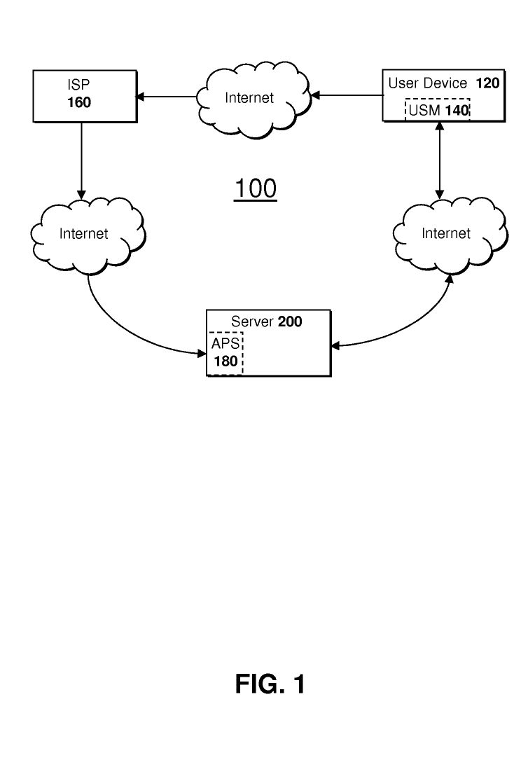

FIG. 1 schematically depicts system 100, according to an embodiment of the invention. The system 100 comprises an end user device 120 that incorporates a user service module (USM) 140, a service provider 160, an account provisioning web service (APS) 180, and a server 200. It should be appreciated that the components of system 100, namely, USM 140, service provider 160, APS 180, and server 200 are configured to communicate with each other via the Internet.

As noted above, a service provider is intended to encompass any entity capable of offering VAS applications. However, in the interest of clarity and tractability, service provider 160 will be described relative to an ISP, with the full understanding that other providers, such as software developers and providers, software distributors, telecommunication service providers, etc. may be incorporated without departing from the spirit of the invention.

The end user device 120 may be any device suitable for requesting access to the Internet, sustaining an Internet session, and processing data traffic on the Internet session. As such, end user device 120 may comprise traditional standalone or laptop personal computers as well as wireless handheld devices, such as mobile phones and personal digital assistants (PDAs).

As will be discussed in greater detail below, end user device 120 includes the USM 140. USM 140 may comprise a desktop application that is configured to deliver scheduled alerts and software updates to end users, communicate with server 200, and manage the download and installation of ISP-offered value-added service (VAS) applications.

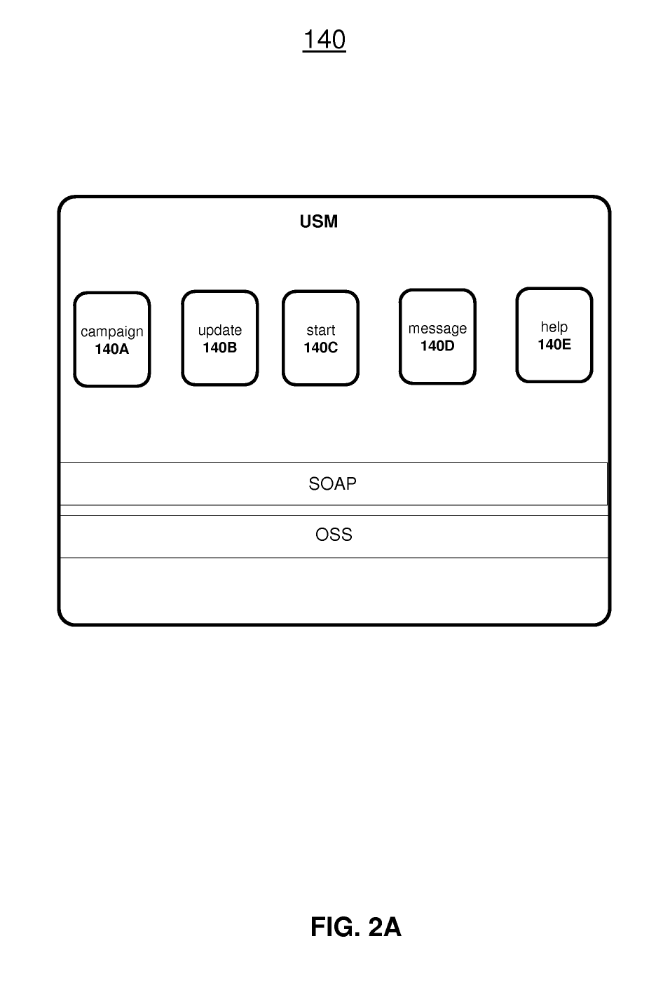

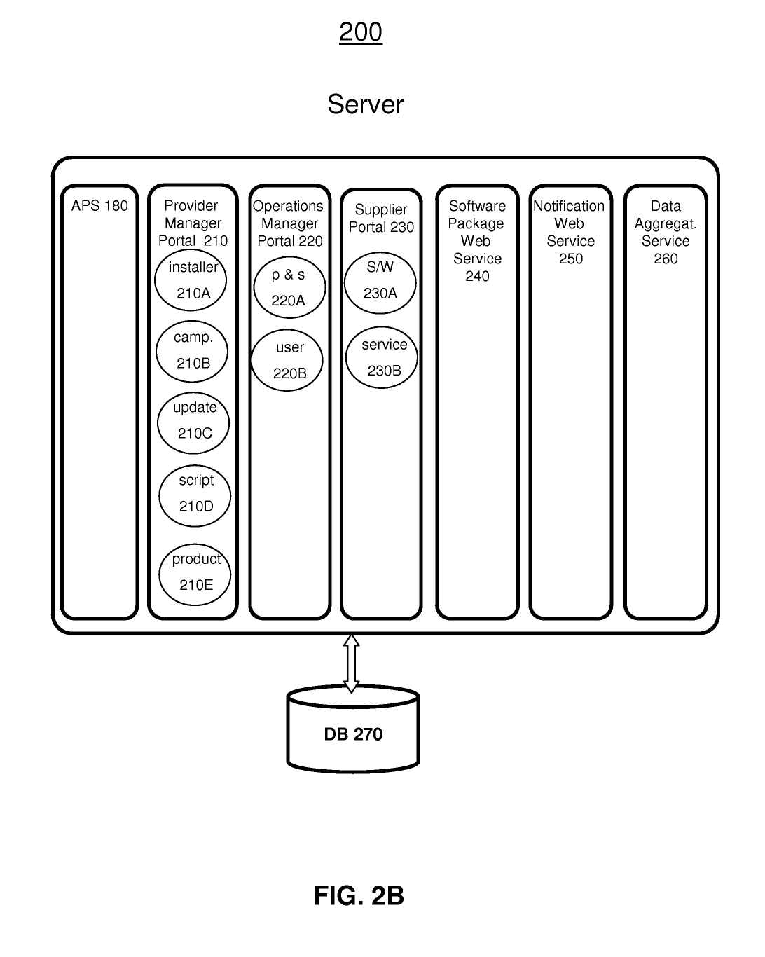

To do this, USM 140 may be configured to operate and be compliant with a number of protocols. For example, as better depicted in FIG. 2A, USM 140 may be configured to operate with simple object access protocol (SOAP), which is a lightweight XML-based messaging protocol used to encode the information in Internet service requests and response messages before sending them over the network. Moreover, USM 140 may be configured to operate with operational support system (OSS) that enables the monitoring, analysis, and management of the networked system and end user device 120.

USM 140 may also be configured to execute various interactive menus and windows on the end user device 120. For example, USM 140 may be equipped with a campaign window 140A, configured to indicate when it is time to advise of a campaign available to the user; an update window 140B, configured to notify the end user of the availability of an update; a start menu 140C, configured to provide a list of USM 140 actions available to the end user; message dialog boxes 140D, configured to convey information related to end user actions; a preferences window, configured to allows end users to set defined preferences, such as language; and a help window 140E, configured to display help topics.

Returning to FIG. 1, server 200 may comprise any computing device that is configured with the software platform and functionality to facilitate the access, download, and successful installation of ISP-offered VAS applications to end user devices 120. In addition, server 200 acts a centralized repository that houses the VAS applications and subscription information associated with all ISPs.

The server 200 also includes an APS 180 module that is configured to manage and process user information and subscriptions. The processing may include the receipt of all account provisioning ISP requests, the forwarding of requests to server 200, the creation, assignment, and management of appropriate authentication credentials.

In one embodiment, server 200 may be configured with a managed service delivery platform (MSDP) which, as better depicted in FIG. 2B, comprises a provider management portal 210, an operations management portal 220, a supplier management portal 230, a software package web service 240, a notification web service 250, and a data aggregation service 260.

In turn, each of the management portals 210, 220, 230, may include a number of management modules configured to perform pre-specified tasks. For example, provider management portal 210 may include an installer download manager module 210A, configured to provide a graphical user interface (GUI) for facilitating targeting and managing the location of installer downloads; a campaign manager module 210B, configured to provide a GUI for creating, reading, updating, and deleting campaigns; an update manager module 210C, configured to provide a GUI for software updates; VAS detection script manager module 210D, configured to provide a GUI for VAS application detection scripts and make them available to USM 140; and a product manager module 210E, configured to provide a GUI that correspond to groups of services offered by the ISP 160 and act as the common identifier for products in the provider's billing system and server.

Similarly, operations management portal 220 may include a provider and supplier manager 220A, configured to provide a GUI used to create, read, update, delete providers and suppliers; and a user manager module 220B, configured to provide a GUI used for user accounts and the configuration of access privileges to the management portals 210, 220, 230.

The supplier management portal 230 may include a software manager module 230A, configured to provide a GUI used to manage the stored software packages and versions that are to be offered by the ISPs; and a software service module 230B, configured to facilitate communications with the USM 140 regarding available software installers and downloads.

The software package web service 240 determines what software packages are available for download and installation. The notification web service 250 transmits and receives information on campaigns and updates, events that occur on the end user device desktop, notification that an end user is no longer a subscriber of the ISP, and receives configuration information, such as scripts for detecting other VAS software. Finally, the data aggregation service 260 records information about devices and events in database 270, as the notification service contacts this service when it receives communications from end user device 120.

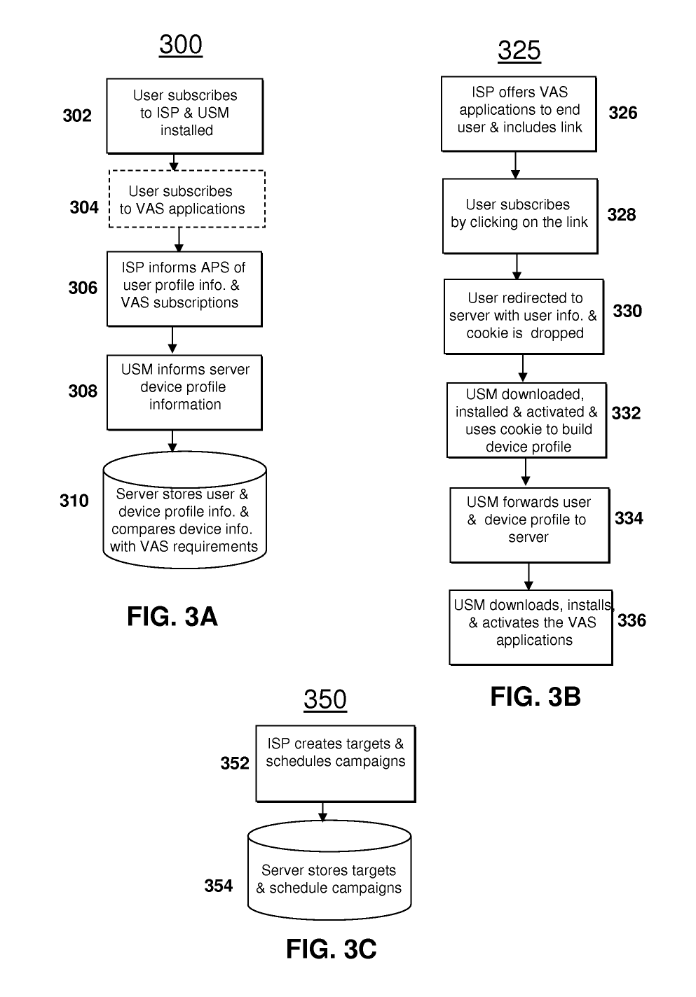

FIG. 3A depicts a flowchart for an initial installation process 300, in accordance with an embodiment of the present invention. In block 302, an end user subscribes to ISP 160 for Internet access service. During the activation process, the USM 140 module is installed on the end user device 120, and information regarding the end user is saved in the registry of end user device 120. Also, as discussed above, USM 140 is an application that is configured to deliver scheduled alerts and software updates to end users as well as manage the download and installation of ISP-offered value-added service (VAS) applications.

It is assumed that ISP 160 offers end user 120 a variety of VAS applications, such as, for example, firewall applications, antivirus applications, gaming applications, multimedia applications, etc. that are stored in server 200. It will also be appreciated that the VAS applications may be bundled as a suite of applications under a corresponding service category. In one embodiment, by virtue of subscribing to ISP 160 for Internet access service, subscriptions to various VAS applications or service categories may be automatic.

In another embodiment, it is contemplated that the end user may select a subscription to the VAS applications or service categories. This is reflected in block 304, where end user 120 selects subscription to at least one of the offered VAS applications.

In response to the VAS subscription, whether automatic or user-selected, the ISP 160 forwards end user 120 attribute/profile information to server 200 and VAS subscriptions via APS 180 at block 306. In block 308, USM 140 forwards end user device 120 profile information to server 200. As discussed above, the APS 180 module is configured to receive account provisioning ISP requests, the forwarding of requests to server 200, the creation, assignment, and management of appropriate authentication credentials.

In block 310, server 200 stores the user and device profile information in database 270 and compares the device 120 profile information with the requirements for the VAS applications or service categories of interest.

FIG. 3B depicts a flowchart for an initial installation process 325, in accordance with another embodiment of the present invention. This embodiment address the situation in which, at the time of initial end user ISP 160 subscription, an ISP 160 was not part of system 100 (FIG. 1)—but at some future date it is. As such, the ISP 160 may notify the end user of an available VAS application via an e-mail or other means and includes a URL link for uploading the application, as depicted in block 326. If the end user desires to subscribe to the VAS application, as noted in block 328, then the end user clicks on the link to upload the VAS application.

The end user is then redirected to server 200 with user information and a cookie is dropped to end user device 200, as in block 330. In block 332, the USM 140 is downloaded, installed, and activated and the USM 140 uses information from the cookie to get user information and builds device profile. Then, the user information and device profile is forwarded to server 200, as depicted in block 334. Finally, in block 336, the USM 140 downloads, installs, and activates the VAS application originally offered in the e-mail.

FIG. 3C depicts a general flowchart for the process 350 of campaigning and distribution of such VAS applications or service categories to the interested public, in accordance with an embodiment of the present invention. As noted above, the server 200 is capable of storing VAS applications and service category bundles for multiple ISPs. In this manner, when a particular ISP desires to offer a set or subset VAS applications and service category bundles to a subscribers, a campaign may be set up in coordination with server 200, in which a target portion of subscribers may be made such offerings and such offerings may be scheduled at predetermined time intervals.

With this said, in block 352, ISP 160 creates targets and schedules a campaign for offering the VAS applications or service bundle categories to a target portion of subscribers. In other words, given the end user and device profiles previously stored in server 200, there is a knowledge base indicative of numerous demographic information, of which the ISP 160 can use to better serve the subscribers. As such, ISP 160 may create target subscribers for a particular suite of VAS applications based on their end user device operating system or whether the end users have previously subscribed to related applications. The targets may also be based on business or enterprise level functionality versus home computer functionality. The targets may also be based on personal information, age, gender, and subscriber ID, as well as whether certain software is installed (and version) or not. It will be appreciated that, given the stored knowledge base, the bases for the created targets can vary greatly.

Once the targets are created, the ISP 160 creates a campaign schedule to offer the targeted subscribers with VAS applications or service bundle categories for their selection. The ISP 160 will direct server 200 to distribute the offerings to the targeted subscribers by indicating the start day or time, the end day or time, a time or day interval, etc.

Finally, in block 354, the targeted subscriber and campaign scheduling information is stored in server 200 for automatic execution by the server 200 in accordance with a throttling process.

Throttling is the process of delivering a campaign or update to a targeted user base over a defined period of time. As noted above, USM 140 is configured to communicate with server 200, such as, for example, through polling for checking whether any campaigns are available to the end user. As such, the throttling process may employ the installation identification information of each USM 140 that polls the back-end during the throttling period, the start time of the campaign or update, and current time on server 200.

Throttling affects the point in time at which a specific USM 140 becomes eligible to receive a notification. The USM 140 should also meet the targeting criteria for the notification. Whether a targeted USM 140 receives a throttled notification when it polls the back-end depends on the USM's 140 number (install ID) produced, which is calculated when the USM 140 polls the back-end. This number is between 0 and 1 and will be identical each time the USM 140 polls. The distribution of values between 0 and 1 is roughly uniform

In addition, the current time on the server 200 is expressed relative to the campaign or update's start time, which is 0, and the end of the throttling period, which is 1.

As such, when a USM 140 polls the backend, the number calculated for the USM 140 is compared to the number calculated for the current time. If the USM 140's number is less than or equal to the number calculated for the current time, the USM 140 receives the notification. If the USM 140's number is greater than the number calculated for the current time, it does not. Each time the USM 140 polls, its number, which is constant, is compared to the current time number.

Once an USM 140 receives a throttled notification, the notification will continue to appear according to its schedule and repeat delay. A throttled notification may be received by USM 140 any time after it becomes eligible until the notification's stop timestamp or de-activation. Therefore, a USM 140 that did not receive the notification because it polled before it was eligible or that did not poll during the throttling period can receive the notification after the throttling period.

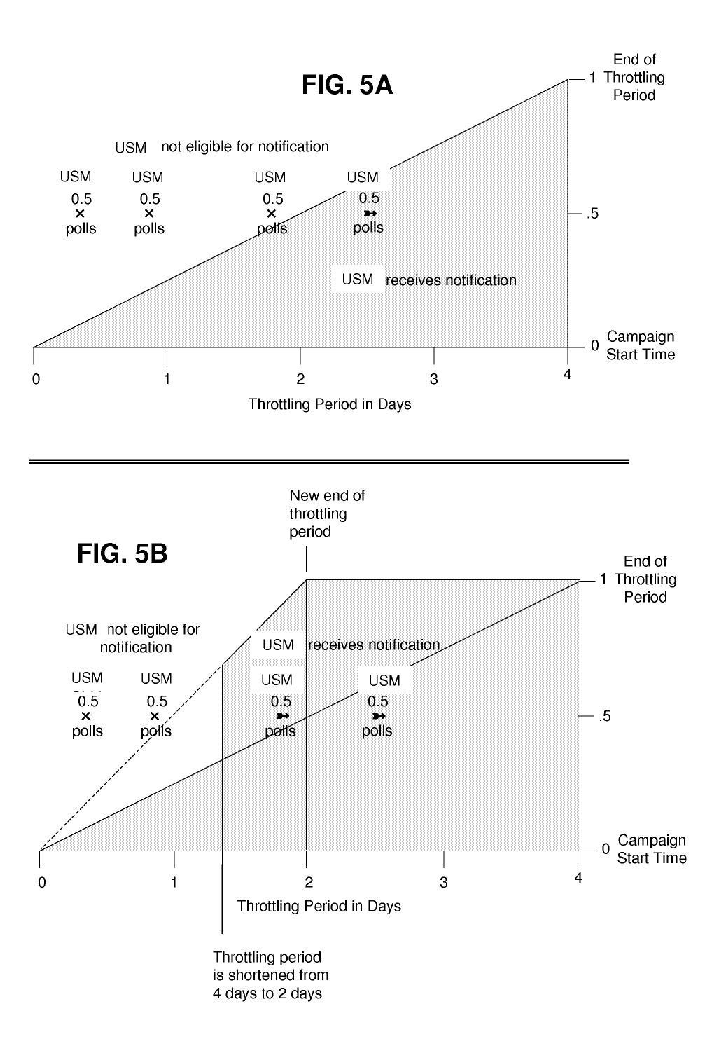

By way of example, consider FIG. 5A, in which a USM 140 with the calculated number 0.5 polls a number of times before being eligible to receive a campaign. (The USM 140 becomes eligible when its calculated number is less than or equal to the current time on the server 200 expressed relative to the start time and end time of the throttling period.)

In FIG. 5B, at a point after Day 1, the throttling period has been shortened from 4 days to 2 days. By shortening the throttling period, the USMs 140, which were not previously eligible, become eligible within the shorter period. Since many USMs 140 will become eligible immediately after changing the period, support calls may increase, particularly, if the change is made at a time many USMs 140 are likely to poll. Likewise, if the throttling period is lengthened after it begins, there may be an immediate drop in the number of USMs 140 that receive the notification as the remaining USMs 140 become eligible over a longer period of time.

It will be appreciated that the described throttling process requires no storage (knowing which USMs 140 have received the campaign is not required) and no lookups have to be performed.

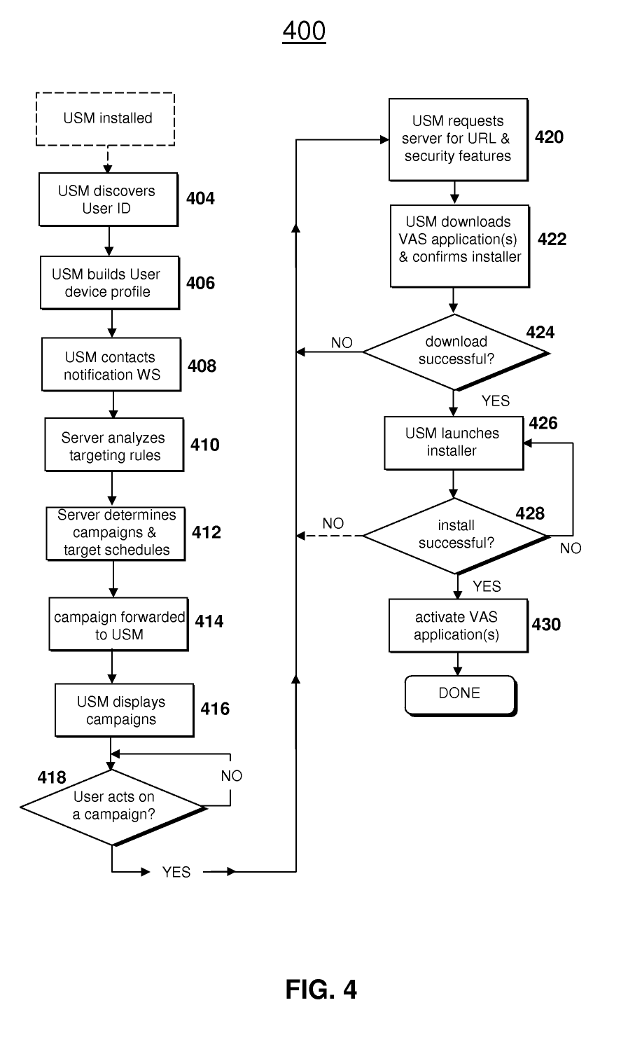

FIG. 4 depicts a flowchart for a process 400 of end-to-end delivery of VAS applications, according to an embodiment of the invention. As discussed above, it is assumed that the USM 140 has been previously installed in the end user device 120. The process 400 is repeated periodically, based on a predetermined schedule, to ensure that the end user device 120 has received the most recent campaigns available to it. In block 404, the USM 140 discovers the end user 120 attribute/profile information that includes identification information (ID) relative to the ISP 160. In block 406, the USM 140 builds an end user device 120 profile information.

In block 408, the USM 140 contacts the notification web service 250 with the end user ID and end user device 120 profile information. As discussed above, the notification service module 230B is configured to facilitate communications with the USM 140 regarding available campaigns, updates, events, and VAS software configuration information.

In block 410, the server 200 analyzes the targeting rules and, in block 412, the server 200 determines campaigns and corresponding target scheduling information that match the end user device 120 profile information. The server 200 then forwards the campaigns and schedules to USM 140, in block 414. In the event that no campaigns match the end user device 120 profile information, then the process is complete, and the process will resume at block 404 the next time the process 400 is initiated.

In block 416, the USM 140 instructs the display of the campaigns to the end user device 120 and in block 418, the end user is prompted through the display, via a pop-up window or other means, and the end user may act on the campaign by clicking on an install link or other feature on the window. The delay in which the campaign selections occur will be affected by the throttling procedure described above.

Upon the end user acting on a campaign, the USM 140 makes a request, in block 420, to the software package web service 240 of server 200 for a URL link to the corresponding VAS application install or update file (as the case may be) associated with the device profile 120 and security features. The security features may comprise, for example, MD5 (Message-Digest algorithm 5), which is a widely used cryptographic hash function with a 128-bit hash value. In block 422, the USM 140 downloads the VAS applications and confirms the associated installer program.

In block 424, process 400 determines whether the download was successful. If not, process 400 branches back to block 420 to again request the URL and security feature and re-download the VAS application and confirms the associated installer program. If the download was successful, the USM 140 launches the associated installer program in block 426.

In block 428, process 400 determines whether the installation of the VAS application was successful. If so, the VAS application is activated by using the end user and end user device profile 120 information, as noted in block 430. The process 400 is complete, and will resume at block 404 the next time the process 400 is initiated. As such, once an end user has acted on a campaign, the corresponding VAS application(s) has been loaded, installed, and activated without further action on the end user's part. If not, then in one embodiment, process 400 may branch back to block 426 to re-launch the associated installer program. This may be iterated several times or iterated for a time period and upon the iteration number or time period lapsing, process 400 may branch back to back to block 420 to again request the URL and security feature and re-download the VAS applications and confirms the associated installer program. In another embodiment, if the installation of the VAS applications was not successful, process 400 may simply branch back 420.

It is contemplated that following a number of unsuccessful attempts at blocks 424 or 426, that a message could be displayed on the end user's device prompting the end user to contact customer service for assistance. It is also contemplated that following a number of unsuccessful attempts at blocks 424 or 426, that information could be sent to the server 200 prompting actions on the server's 200 end to verify the cause of the unsuccessful attempts and, if necessary, provide a new or modified version of the VAS application to be downloaded.

In this manner, given the knowledge base of end user and device profiles stored in server 200, the end-to-end delivery of VAS applications are conducted virtually automatically and transparently, with minimal end user intervention

Moreover, specific events or tasks may be recorded, collected, and reported by the server 200 to provide the ISP 160 with some indicia of installation productivity. For example, in some embodiments, the display of campaigns (see, block 416), the acting on a displayed campaign (see, block 418), the downloading of the VAS application(s) (see, block 422), the success of the download (see, block 424), and/or the success of the install (see, block 428) may be recorded and then reported out to the ISP 160. Armed with such information, the ISP 160 may modify its campaign or associated operations, including, for example, changing the look of the campaign, changing the message in the pop-up window on the end user device 120 etc. to improve the number of end user installs.

While specific embodiments of the invention have been described above, it will be appreciated that the invention may be practiced otherwise than as described. The description is not intended to limit the invention—rather the scope of the invention is defined by the appended claims.

What is claimed is:

1. A method of delivering value added service (VAS) applications offered by a service provider to a subscribing end user, comprising:
collecting, by a user service module, end user device information;
forwarding, by the service provider, end user information, to a server;
creating, by the service provider, target end user profiles, VAS application campaigns, and campaign schedules;
storing the end user information, the end user device information, the target end user profiles, the VAS application campaigns, and the campaign schedules in the server;
communicating, between the server and the user service module, to display an offer in the end user device for at least one of the VAS applications, in accordance with the target end user profiles, the VAS application campaigns, and the campaign schedules,
wherein, upon selecting by the user, the at least one of the VAS applications is loaded, installed, and activated in the end user device without further end user actions.

2. The method of claim 1, further comprising installing the user service module on the end user device.

3. The method of claim 2, wherein the installation of the user service module occurs during the initial subscription with the service provider.

4. The method of claim 2, wherein the installation of the user service module occurs by:
offering a VAS application to the end user via a uniform resource locator (URL) link;
redirecting the end user to the server where an Internet cookie is deposited, upon the user clicking on the URL link; and
downloading and installing the user service module.

5. The method of claim 1, wherein the forwarding of the end user information is transmitted to an account provisioning service of the server.

6. The method of claim 1, wherein the communicating between the server and the user service module, comprises:
contacting, by the user service module, the server with end user device information;
determining, by the server, corresponding target end user profiles, VAS application campaigns, and campaign schedules based on the end user information and the end user device information and
forwarding, by the server, the corresponding VAS application campaign.

7. The method of claim 1, wherein the display of the offer comprises having the user service module initiate a pop-up window in the end user device.

8. The method of claim 7, wherein selecting by the end user, comprises the end user actively clicking on a link provided on the pop-up window.

9. The method of claim 8, further comprising:
requesting, by the user service module, a uniform resource locator and security feature from the server;
downloading, by the user service module, the VAS application; and
confirming installer for VAS application.

10. The method of claim 9, wherein the user service module determines whether the download was successful.

11. The method of claim 10, wherein the user service module determines whether the installation was successful.

12. The method of claim 11, further comprising recording, by the server, information regarding at least one of the display of the offer, the selecting by the end user, and the determination of whether the download and installation was successful.

13. The method of claim 12, further comprising reporting, by the server to the service provider, the information regarding the at least one of the display of the offer, the selecting by the end user, and the determination of whether the download and installation was successful.

14. The method of claim 1, further comprising delivering the VAS application campaigns to target end users based on the campaign schedules in accordance with a throttling procedure.

15. The method of claim 14, wherein the throttling procedure comprises:
incorporating installation identification information of each user service module that polls the server to calculate a user service module number;
incorporating the start time of the campaign or update; and
incorporating the current time on the server.

16. The method of claim 15, wherein the current time on the server is expressed relative to the campaign or update's start time and the end of the throttling period.

17. The method of claim 16, further comprising:
comparing the user service module number to the number calculated for the current time on the server,
wherein, when user service module number is less than or equal to the current time on the server, the user service module receives the campaign or notification.

18. The method of claim 17, further comprising:
continuing the campaign or notification according to the campaign schedule and repeat delay; and
terminating the campaign or notification according to a stop timestamp or deactivation time.

19. A system for delivering value added service (VAS) applications offered by a service provider to a subscribing end user, comprising:
an end user device incorporating a user service module that is configured to collect end user device information;
a server configured to receive and store end user information from the service provider, end user device information from the user service module, and target end user profiles, VAS application campaigns, and campaign schedules created by the service provider; wherein the server and the user service module communicate to display an offer in the end user device for at least one of the VAS applications, in accordance with the target end user profiles, the VAS application campaigns, and the campaign schedules,
wherein, upon selecting by the user, the at least one of the VAS applications is loaded, installed, and activated in the end user device without further end user actions.

20. The system of claim 19, wherein the user service module is configured to execute at least one of:
a campaign window to indicate when it is time to advise of a campaign available to the end user;
an update window to notify the end user of an availability of an update;
a start menu to provide a list of user service module actions available to the end user;
message dialog boxes to convey information related to the end user actions;
a preferences window to allow end users to set defined preferences; and
a help window to display help topics.

21. The system of claim 19, wherein the server comprises at least one of:
a provider management portal;
an operations management portal; and
a supplier management portal.

22. The system of claim 21, wherein the server further comprises at least one of:
a software package web service;
a notification web service; and
a data aggregation service.

23. The system of claim 21, wherein the provider management portal comprises at least one of:
an installer download manager module to provide a graphical user interface (GUI) for facilitating targeting and managing the location of installer downloads;
a campaign manager module to provide a GUI for creating, reading, updating, and deleting campaigns;
an update manager module to provide a GUI for software updates;
a VAS detection script manager module to provide a GUI for VAS application detection scripts and make them available to the user service module; and
a product manager module to provide a GUI that correspond to groups of services offered by the service provider and act as the common identifier for service provider products.

24. The system of claim 21, wherein the operations management portal comprises at least one of:
a provider and supplier manager to provide a GUI used to create, read, update, delete providers and suppliers; and
a user manager module to provide a GUI used for user accounts and configuration of access privileges to the management portals.

25. The system of claim 21, wherein the supplier management portal comprises at least one of:
a software manager module to provide a GUI used to manage stored software packages and versions that are to be offered by the service provider; and
a software service module to facilitate communications with the user service module regarding available software installers and downloads.
